(19) United States
(12) Patent Application Publication
(10) Pub. No.: US 2018/0335672 A1
(43) Pub. Date: Nov. 22, 2018

(54) PIXEL ELECTRODE AND CURVED LIQUID CRYSTAL DISPLAY PANEL

(71) Applicant: Shenzhen China Star Optoelectronics Technology Co., Ltd., Shenzhen City (CN)

(72) Inventor: Yanxi Ye, Shenzhen City (CN)

(21) Appl. No.: 15/326,650

(22) PCT Filed: Dec. 16, 2016
(86) PCT No.: PCT/CN2016/110237

§ 371 Date: Jan. 17, 2017

(30) Foreign Application Priority Data
Aug. 26, 2016 (CN) 201610741738.2

(51) Int. Cl. G02F 1/1343

(52) U.S. Cl. CPC G02F 1/134309; G02F 2201/56; G02F 2201/123; G02F 1/13439

(57) ABSTRACT

The present invention provides a pixel electrode and a curved liquid crystal display panel. The pixel electrode is applicable to the production of a curved liquid crystal display panel and includes four electrode zones arranged in sequence in the vertical direction. Connection electrodes are provided in each of the electrode zones and between each of the electrode zones, and each of the electrode zones is provided therein with branch electrodes. The branch electrodes of each of the electrode zones are connected through the connection electrodes and among four connection electrodes that are respectively arranged in the four electrode zones, at most two are vertical electrodes that extend in the vertical direction, and the remaining ones are arranged in the horizontal direction or in directions that are inclined with respect to the horizontal direction so as to reduce influence caused by an electric field induced between the vertical electrodes on the left and right edges of the pixel electrode and thus improving dark pattern phenomenon of the liquid crystal display and increasing transmission rate.

### BACKGROUND OF THE INVENTION

### 1. Field of the Invention

The present invention relates to the field of display technology, and more particular to a pixel electrode and a curved liquid crystal display panel.

### 2. The Related Arts

Liquid crystal display (LCD) has various advantages, such as thin device body, low power consumption, and being free of radiation, and is widely used, such as liquid crystal televisions, mobile phones, personal digital assistants (PDAs), digital cameras, computer displays, or notebook computer screens, and takes a leading position in the field of flat panel displays.

A liquid crystal display device generally comprises an enclosure, a liquid crystal panel arranged in the enclosure, and a backlight module arranged in the enclosure. The liquid crystal panel has a structure that is made up of a thin-film transistor (TFT) array substrate, a color filter (CF) substrate, and a liquid crystal layer arranged between the two substrates, wherein the operation principle is that a drive voltage is applied to a pixel electrode on the TFT substrate and a common electrode on the CF substrate to control rotation of liquid crystal molecules of the liquid crystal layer in order to refract out light emitting from the backlight module to generate an image.

Recently, with the development of the liquid crystal technology, major manufacturers have each proposed curved liquid crystal displays. Generally speaking, a curved liquid crystal display can provide the best viewing effect from one edge thereof to another edge, while a regular liquid crystal display shows poor capability of displaying at edges of a screen thereof. The curved liquid crystal display has a design that provides a screen that is curved in the entirety thereof so as to provide a wide full-view image effect, achieving the same visual enjoyment for both a center and a periphery of the screen, also helping reducing distortion of off-axis observation for observation at a short distance. In addition, the curved liquid crystal display allows the observation distance of user to be elongated to provide better experience of watching. Thus, the curved liquid crystal display is significantly advantageous, compared to the regular liquid crystal displays.

For a curved liquid crystal display, a pixel electrode used must be designed for shape deformation on the basis of a regular liquid crystal display in order to facilitate curving of the liquid crystal display. With reference to FIG. 1, FIG. 1 shows a pixel electrode of a conventional curved liquid crystal display, in which a regular pixel electrode having a shape of superimposed saltire and cross is divided into two halves along a vertical central line thereof, wherein the right-half part of the pixel electrode is jointed to an underside of the left-half part of the pixel electrode in order to ensure the pixels of all areas are shifted by the same amount when an LCD is curved and thus ensuring a desired displaying performance. Specifically, referring to FIG. 1, the above-described pixel electrode comprises: totally four, first to fourth, electrode zones 101, 102, 103, 104, wherein the first, second, third, and fourth electrode zones 101, 102, 103, 104 are respectively provided with a plurality of first, the second, the third, the fourth branch electrodes 201, 202, 203, 204, in the form of strips substantially parallel to and spaced from each other and respectively inclined with respect to a horizontal direction by a degrees, a+90 degrees, −a degrees, and −(a+90) degrees. The first branch electrodes 201 and the second branch electrodes 202 are provided, at a right side thereof, with first and second connection electrodes 301, 302 extending in a vertical direction and the third branch electrodes 203 and the fourth branch electrodes 204 are provided, at a left side thereof, with third and fourth connection electrodes 303, 304 extending in a vertical direction. The first electrode zone 101 and the second electrode zone 102 are provided therebetween with a fifth connection electrode 305 extending in a horizontal direction and the third electrode zone 103 and the fourth electrode zone 104 are provided therebetween with a sixth connection electrode 306 extending in a horizontal direction. A lower end of the first connection electrode 301 is connected to an upper end of the second connection electrode 302 and a right end of the fifth connection electrode 305; and a lower end of the third connection electrode 303 is connected to an upper end of the fourth connection electrode 304 and a left end of the sixth connection electrode 306. The plurality of first branch electrodes 201 are connected to each other through the first connection electrode 301 and the fifth connection electrode 305; the plurality of second branch electrodes 202 are connected to each other through the second connection electrode 302 and the fifth connection electrode 305; the plurality of third branch electrodes 203 are connected to each other through the third connection electrode 303 and the sixth connection electrode 306; and the plurality of fourth branch electrodes 204 are connected to each other through the fourth connection electrode 304 and the sixth connection electrode 306. The second electrode zone 102 and the third electrode zone 103 are connected to each other through a seventh connection electrode 307 therebetween. In the above-described pixel electrode, the first, second, third, and fourth connection electrodes 301, 302, 303, 304 are all arranged to extend the vertical direction, so that the four electrode zones may be caused to generate dark patterns, thus affecting the transmission rate of the liquid crystal display panel.

### SUMMARY OF THE INVENTION

An objective of the present invention is to provide a pixel electrode that is applicable to a curved liquid crystal display panel to reduce dark patterns generated in the curved liquid crystal display panel and increase transmission rate of the curved liquid crystal display panel.

Another objective of the present invention is to provide a curved liquid crystal display panel, which uses the above-described pixel electrode to improve a dark pattern phenomenon and enhance transmission rate and displaying performance thereof.

To achieve the above objective, the present invention provides a pixel electrode, which comprises: a plurality of first, second, third, and fourth branch electrodes, in the form of strips, and first, second, third, fourth, fifth, sixth, and seventh connection electrodes;

wherein the pixel electrode comprises first, second, third, and fourth electrode zones, which are rectangular in shape and arranged in sequence in a vertical direction from top to bottom;

the plurality of first branch electrodes are arranged in the first electrode zone and the plurality of first branch electrodes are substantially parallel to and spaced from each other, and the first connection electrode and the second connection electrode connect the plurality of first branch electrodes to each other; the plurality of second branch electrodes are arranged in the second electrode zone and the plurality of second branch electrodes are substantially parallel to and spaced from each other, and the second connection electrode and the third connection electrode connect the plurality of second branch electrodes to each other; the plurality of third branch electrodes are arranged in the third electrode zone and the plurality of third branch electrodes are substantially parallel to and spaced from each other, and the fourth connection electrode and the fifth connection electrode connect the plurality of third branch electrodes to each other; and the plurality of fourth branch electrodes are arranged in the fourth electrode zone and the plurality of fourth branch electrodes are substantially parallel to and spaced from each other, and the fifth connection electrode and the sixth connection electrode connect the plurality of fourth branch electrodes to each other; and

the first connection electrode is arranged at an upper side of the first electrode zone and extends in a horizontal direction, or alternatively, the first connection electrode is arranged in the first electrode zone and extends in a direction that is inclined with respect to the horizontal direction; the second connection electrode is arranged between the first electrode zone and the second electrode zone and extends in the horizontal direction; the third connection electrode is arranged at a left side or a right side of the second electrode zone and extends in the vertical direction, or alternatively, the third connection electrode is arranged at a lower side of the second electrode zone and extends in the horizontal direction, or alternatively, the third connection electrode is arranged in the second electrode zone and extends in a direction that is inclined with respect to the horizontal direction; the fourth connection electrode is arranged at a left side or a right side of the third electrode zone and extends in the vertical direction, or alternatively, the fourth connection electrode is arranged at an upper side of the third electrode zone and extends in the horizontal direction, or alternatively, the fourth connection electrode is arranged in the third electrode zone and extends in a direction that is inclined with respect to the horizontal direction; the fifth connection electrode is arranged between the third electrode zone and the fourth electrode zone and extends in the horizontal direction; the sixth connection electrode is arranged at a lower side of the fourth electrode zone and extends in the horizontal direction, or alternatively, the sixth connection electrode is arranged in the fourth electrode zone and extends in a direction that is inclined with respect to the horizontal direction; and the seventh connection electrode is arranged between the second electrode zone and the third electrode zone and connects the electrodes of the second electrode zone and the third electrode zone together.

The plurality of first and fourth branch electrodes are both inclined with respect to the horizontal direction by a degrees and the plurality of second and third branch electrodes are both inclined with respect to the horizontal direction by a+90 degrees, where a is greater than 0 and smaller than 90.

The plurality of first and fourth branch electrodes are both inclined with respect to the horizontal direction by 45 degrees and the plurality of second and third branch electrodes are both inclined with respect to the horizontal direction by 135 degrees.

The pixel electrode is formed of a material comprising a metal or a metal oxide.

The material of the pixel electrode is indium tin oxide (ITO).

The present invention also provides a curved liquid crystal display panel, which comprises: a first substrate and a second substrate that are opposite to each other, the second substrate comprising a pixel electrode arranged thereon;

wherein the pixel electrode comprises: a plurality of first, second, third, and fourth branch electrodes, in the form of strips, and first, second, third, fourth, fifth, sixth, and seventh connection electrodes;

wherein the pixel electrode comprises first, second, third, and fourth electrode zones, which are rectangular in shape and arranged in sequence in a vertical direction from top to bottom;

the plurality of first branch electrodes are arranged in the first electrode zone and the plurality of first branch electrodes are substantially parallel to and spaced from each other, and the first connection electrode and the second connection electrode connect the plurality of first branch electrodes to each other; the plurality of second branch electrodes are arranged in the second electrode zone and the plurality of second branch electrodes are substantially parallel to and spaced from each other, and the second connection electrode and the third connection electrode connect the plurality of second branch electrodes to each other; the plurality of third branch electrodes are arranged in the third electrode zone and the plurality of third branch electrodes are substantially parallel to and spaced from each other, and the fourth connection electrode and the fifth connection electrode connect the plurality of third branch electrodes to each other; and the plurality of fourth branch electrodes are arranged in the fourth electrode zone and the plurality of fourth branch electrodes are substantially parallel to and spaced from each other, and the fifth connection electrode and the sixth connection electrode connect the plurality of fourth branch electrodes to each other; and

the first connection electrode is arranged at an upper side of the first electrode zone and extends in a horizontal direction, or alternatively, the first connection electrode is arranged in the first electrode zone and extends in a direction that is inclined with respect to the horizontal direction; the second connection electrode is arranged between the first electrode zone and the second electrode zone and extends in the horizontal direction; the third connection electrode is arranged at a left side or a right side of the second electrode zone and extends in the vertical direction, or alternatively, the third connection electrode is arranged at a lower side of the second electrode zone and extends in the horizontal direction, or alternatively, the third connection electrode is arranged in the second electrode zone and extends in a direction that is inclined with respect to the horizontal direction; the fourth connection electrode is arranged at a left side or a right side of the third electrode zone and extends in the vertical direction, or alternatively, the fourth connection electrode is arranged at an upper side of the third electrode zone and extends in the horizontal direction, or alternatively, the fourth connection electrode is arranged in the third electrode zone and extends in a direction that is inclined with respect to the horizontal direction; the fifth connection electrode is arranged between the third electrode zone and the fourth electrode zone and extends in the horizontal direction; the sixth connection electrode is arranged at a lower side of the fourth electrode zone and extends in the horizontal direction, or alternatively, the sixth connection electrode is arranged in the fourth electrode zone and extends in a direction that is inclined with respect to the horizontal direction; and the seventh connection electrode is arranged between the second electrode zone and the third electrode zone and connects the electrodes of the second electrode zone and the third electrode zone together.

The plurality of first and fourth branch electrodes are both inclined with respect to the horizontal direction by a degrees and the plurality of second and third branch electrodes are both inclined with respect to the horizontal direction by a+90 degrees, where a is greater than 0 and smaller than 90.

The plurality of first and fourth branch electrodes are both inclined with respect to the horizontal direction by 45 degrees and the plurality of second and third branch electrodes are both inclined with respect to the horizontal direction by 135 degrees.

The pixel electrode is formed of a material comprising a metal or a metal oxide.

The material of the pixel electrode is ITO.

The present invention further provides a curved liquid crystal display panel, which comprises: a first substrate and a second substrate that are opposite to each other, the second substrate comprising a pixel electrode arranged thereon;

wherein the pixel electrode comprises: a plurality of first, second, third, and fourth branch electrodes, in the form of strips, and first, second, third, fourth, fifth, sixth, and seventh connection electrodes;

wherein the pixel electrode comprises first, second, third, and fourth electrode zones, which are rectangular in shape and arranged in sequence in a vertical direction from top to bottom;

the plurality of first branch electrodes are arranged in the first electrode zone and the plurality of first branch electrodes are substantially parallel to and spaced from each other, and the first connection electrode and the second connection electrode connect the plurality of first branch electrodes to each other; the plurality of second branch electrodes are arranged in the second electrode zone and the plurality of second branch electrodes are substantially parallel to and spaced from each other, and the second connection electrode and the third connection electrode connect the plurality of second branch electrodes to each other; the plurality of third branch electrodes are arranged in the third electrode zone and the plurality of third branch electrodes are substantially parallel to and spaced from each other, and the fourth connection electrode and the fifth connection electrode connect the plurality of third branch electrodes to each other; and the plurality of fourth branch electrodes are arranged in the fourth electrode zone and the plurality of fourth branch electrodes are substantially parallel to and spaced from each other, and the fifth connection electrode and the sixth connection electrode connect the plurality of fourth branch electrodes to each other; and

the first connection electrode is arranged at an upper side of the first electrode zone and extends in a horizontal direction, or alternatively, the first connection electrode is arranged in the first electrode zone and extends in a direction that is inclined with respect to the horizontal direction; the second connection electrode is arranged between the first electrode zone and the second electrode zone and extends in the horizontal direction; the third connection electrode is arranged at a left side or a right side of the second electrode zone and extends in the vertical direction, or alternatively, the third connection electrode is arranged at a lower side of the second electrode zone and extends in the horizontal direction, or alternatively, the third connection electrode is arranged in the second electrode zone and extends in a direction that is inclined with respect to the horizontal direction; the fourth connection electrode is arranged at a left side or a right side of the third electrode zone and extends in the vertical direction, or alternatively, the fourth connection electrode is arranged at an upper side of the third electrode zone and extends in the horizontal direction, or alternatively, the fourth connection electrode is arranged in the third electrode zone and extends in a direction that is inclined with respect to the horizontal direction; the fifth connection electrode is arranged between the third electrode zone and the fourth electrode zone and extends in the horizontal direction; the sixth connection electrode is arranged at a lower side of the fourth electrode zone and extends in the horizontal direction, or alternatively, the sixth connection electrode is arranged in the fourth electrode zone and extends in a direction that is inclined with respect to the horizontal direction; and the seventh connection electrode is arranged between the second electrode zone and the third electrode zone and connects at least one of the second branch electrodes to the third branch electrodes;

wherein the plurality of first and fourth branch electrodes are both inclined with respect to the horizontal direction by a degrees and the plurality of second and third branch electrodes are both inclined with respect to the horizontal direction by a+90 degrees, where a is greater than 0 and smaller than 90; and

wherein the pixel electrode is formed of a material comprising a metal or a metal oxide.

The efficacy of the present invention is that the present invention provides a pixel electrode. The pixel electrode is applicable to the production of a curved liquid crystal display panel and comprises four electrode zones arranged in sequence in the vertical direction. Connection electrodes are provided in each of the electrode zones and between each of the electrode zones, and each of the electrode zones is provided therein with branch electrodes, wherein the branch electrodes of each of the electrode zones are connected through the connection electrodes and among four connection electrodes that are respectively arranged in the four electrode zones, at most two are vertical electrodes that extend in the vertical direction, and the remaining ones are arranged in the horizontal direction or in directions that are inclined with respect to the horizontal direction so as to reduce influence caused by an electric field induced between the vertical electrodes on the left and right edges of the pixel electrode and thus improving dark pattern phenomenon of the liquid crystal display and increasing transmission rate. The present invention also provides a curved liquid crystal display panel, which uses the above-described pixel electrode, so as to improve the dark pattern phenomenon, enhance the transmission rate, and exhibit excellent displaying performance.

### BRIEF DESCRIPTION OF THE DRAWINGS

For better understanding of the features and technical contents of the present invention, reference will be made to the following detailed description of the present invention, in combination with the attached drawings. However, the drawings are provided only for reference and illustration and are not intended to limit the present invention.

In the drawings:

FIG. 1 is a schematic view illustrating the structure of a conventional pixel electrode that is applicable to a curved liquid crystal display panel;

FIG. 2 is a schematic view illustrating the structure of a first embodiment of a pixel electrode according to the present invention; and

FIG. 3 is a schematic view illustrating the structure of a second embodiment of the pixel electrode according to the present invention; and

FIG. 4 is a schematic view illustrating the structure of a third embodiment of the pixel electrode according to the present invention.

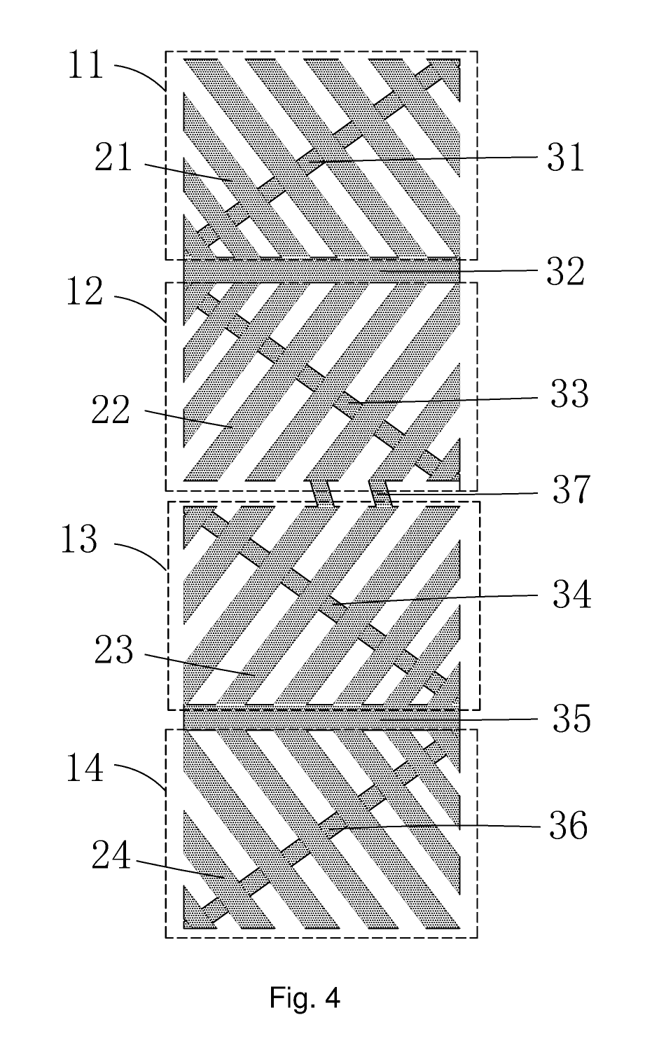

### DETAILED DESCRIPTION OF THE PREFERRED EMBODIMENTS

To further expound the technical solution adopted in the present invention and the advantages thereof, a detailed description will be given with reference to the preferred embodiments of the present invention and the drawings thereof.

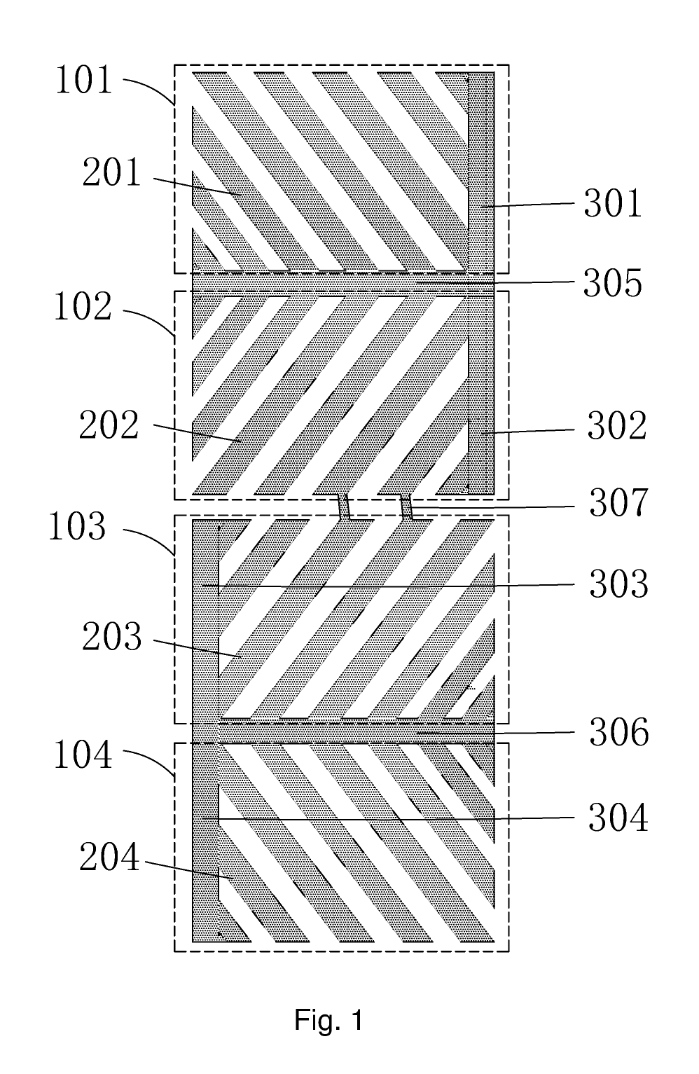

Referring to FIG. 1, in a first embodiment of a pixel electrode provided by the present invention, the pixel electrode comprises: a plurality of first, second, third, and fourth branch electrodes 21, 22, 23, 24, in the form of strips, and first, second, third, fourth, fifth, sixth, and seventh connection electrode 31, 32, 33, 34, 35, 36, 37.

The pixel electrode comprises first, second, third, and fourth electrode zones 11, 12, 13, 14, which are rectangular in shape and arranged in sequence in a vertical direction from top to bottom.

The plurality of first branch electrodes 21 are arranged in the first electrode zone 11 and the plurality of first branch electrodes 21 are substantially parallel to and spaced from each other, and the first connection electrode 31 and the second connection electrode 32 connect the plurality of first branch electrodes 21 to each other; the plurality of second branch electrodes 22 are arranged in the second electrode zone 12 and the plurality of second branch electrodes 22 are substantially parallel to and spaced from each other, and the second connection electrode 32 and the third connection electrode 33 connect the plurality of second branch electrodes 22 to each other; the plurality of third branch electrodes 23 are arranged in the third electrode zone 13 and the plurality of third branch electrodes 23 are substantially parallel to and spaced from each other, and the fourth connection electrode 34 and the fifth connection electrode 35 connect the plurality of third branch electrodes 23 to each other; the plurality of fourth branch electrodes 24 are arranged in the fourth electrode zone 14 and the plurality of fourth branch electrodes 24 are substantially parallel to and spaced from each other, and the fifth connection electrode 35 and the sixth connection electrode 36 connect the plurality of fourth branch electrodes 24 to each other; wherein the first, third, fourth, and sixth connection electrodes 31, 33, 34, 36 are electrodes arranged inside the electrode zones, while the second, fifth, and seventh connection electrodes 32, 35, 37 are electrodes arranged between the electrode zones.

Specifically, each of the first branch electrodes 21 is connected to at least one of the first connection electrode 31 and the second connection electrode 32 and the first connection electrode 31 and the second connection electrode 32 are connected or at least one of the first branch electrodes 21 is simultaneously connected to the first connection electrode 31 and the second connection electrode 32, so that the plurality of first branch electrodes 21 are in connection with each other through the first connection electrode 31 and the second connection electrode 32; each of the second branch electrodes 22 is connected to at least one of the second connection electrode 32 and the third connection electrode 33 and the first connection electrode 32 and the third connection electrode 33 are connected or at least one of the second branch electrodes 22 is simultaneously connected to the second connection electrode 32 and the third connection electrode 33, so that the plurality of second branch electrodes 21 are in connection with each other through the second connection electrode 32 and the third connection electrode 33; each of the third branch electrodes 23 is connected to at least one of the fourth connection electrode 34 and the fifth connection electrode 35 and the fourth connection electrode 34 and the fifth connection electrode 35 are connected or at least one of the third branch electrodes 23 is simultaneously connected to the fourth connection electrode 34 and the fifth connection electrode 35, so that the plurality of third branch electrodes 23 are in connection with each other through the fourth connection electrode 34 and the fifth connection electrode 35; each of the fourth branch electrodes 24 is connected to at least one of the fifth connection electrode 35 and the sixth connection electrode 36 and the fifth connection electrode 35 and the sixth connection electrode 36 are connected or at least one of the fourth branch electrodes 24 is simultaneously connected to the fifth connection electrode 35 and the sixth connection electrode 36, so that the plurality of fourth branch electrodes 24 are in connection with each other through the fifth connection electrode 35 and the sixth connection electrode 36.

Specifically, the plurality of first and fourth branch electrodes 21, 24 are both inclined with respect to a horizontal direction by an angle of a degrees and the plurality of second and third branch electrodes 22, 23 are both inclined with respect to the horizontal direction by an angle of a+90 degrees, where a is greater than 0 and smaller than 90, such that in the liquid crystal display panel, liquid crystal corresponding to the first and fourth electrode zones 11, 14 and liquid crystal corresponding to the second and the third electrode zone 12, 13 are tilted in different directions. Preferably, the plurality of first and fourth branch electrodes 21, 24 are both inclined with respect to the horizontal direction by 45 degrees and the plurality of second and third branch electrodes 22, 23 are both inclined with respect to the horizontal direction by 135 degrees.

Specifically, in the first embodiment of the present invention, the first connection electrode 31 is arranged at an upper side of the first electrode zone 11 and extends in a horizontal direction; the second connection electrode 32 is arranged between the first electrode zone 11 and the second electrode zone 12 and extends in a horizontal direction; the third connection electrode 33 is arranged at a right side of the second electrode zone 12 and extends in a vertical direction; the fourth connection electrode 34 is arranged at a left side of the third electrode zone 13 and extends in a vertical direction; the fifth connection electrode 35 is arranged between the third electrode zone 13 and the fourth electrode zone 14 and extends in a horizontal direction; the sixth connection electrode 36 is arranged at a lower side of the fourth electrode zone 14 and extends in a horizontal direction; the seventh connection electrode 37 is arranged between the second electrode zone 12 and the third electrode zone 13 and connect two of the second branch electrodes 22 and the third branch electrodes 23 to each other so that the branch electrodes of the entirety of the pixel electrode are in connection with each other through the connection electrodes.

The first branch electrodes 21 that are connected to the first connection electrode 31 each have an end connected to the first connection electrode 31 and an opposite end that is either suspended or connected to the second connection electrode 32 according a location where the first branch electrode 21 is set; the second branch electrodes 22 that are connected to the second connection electrode 32 each have an end connected to the second connection electrode 32 and an opposite end that is either suspended or connected to the third connection electrode 33 according a location where the second branch electrode 22 is set; the third branch electrodes 21 that are connected to the fourth connection electrode 34 each have an end connected to the fourth connection electrode 34 and an opposite end that is either suspended or connected to the fifth connection electrode 35 according a location where the second branch electrode 22 is set; the fourth branch electrodes 24 that are connected to the fifth connection electrode 35 each have an end connected to the fifth connection electrode 35 and an opposite end that is either suspended or connected to the sixth connection electrode 36 according a location where the fourth branch electrode 24 is set.

It is appreciated that in the first embodiment of the present invention, the third connection electrode 33 and the fourth connection electrode 34 are respectively arranged at the right side and the left side of the pixel electrode, but this is not intended to limit the present invention. Besides the arrangement that the third connection electrode 33 and the fourth connection electrode 34 are respectively set at the right side and the left side of the pixel electrode, it may be alternatively arranged such that the third connection electrode 33 is set at the left side, while the fourth connection electrode 34 is at the right side, or both the third connection electrode 33 and the fourth connection electrode 34 are set at either the left side or the right side. Under the same condition, it is preferred to have the third connection electrode 33 and the fourth connection electrode 34 set at different sides. In addition, the seventh connection electrode 37 functions to connect the electrodes in the second electrode zone 12 and the third electrode zone 13 to one another so as to form an integrated unitary pixel electrode. Although the first embodiment adopts the technical solution in which two of the second branch electrodes 22 are respectively connected with two of the third branch electrodes 23, this is not intended to limit the present invention, and if desired and optionally, an arbitrary number of the second branch electrodes 22, such as one or three, can be connected to the third branch electrodes 23, or an alternative technical solution in which the second branch electrodes 22 and the fourth connection electrode 34 are connected can be adopted, provided the purpose of connecting the electrodes in the second electrode zone 12 and the third electrode zone 13 to each other can be achieved.

Specifically, the pixel electrode as illustrated is formed of a material comprising a metal or a metal oxide, and a preferred material is indium tin oxides (ITO).

It is noted here that since the four electrode zones of the above-described pixel electrode are arranged in sequence in the vertical direction, in an application thereof to a curved liquid crystal display panel, it is possible to ensure the pixel shifting amount of each of the electrode zones is identical during curving and thus ensuring displaying performance of the curved liquid crystal display panel, and being different from the prior art, the present invention is structured to have the first and sixth connection electrodes 31, 36 of the first and fourth electrode zones 11, 14 extending in a horizontal direction, instead of extending in a vertical direction. Such a modification being not affecting direct connection of each electrode, while preventing the generation of dark patterns within each of the electrode zones resulting from the connection electrodes of the electrode zones all extending in the vertical direction so as to help improve transmission rate and displaying performance of a liquid crystal display.

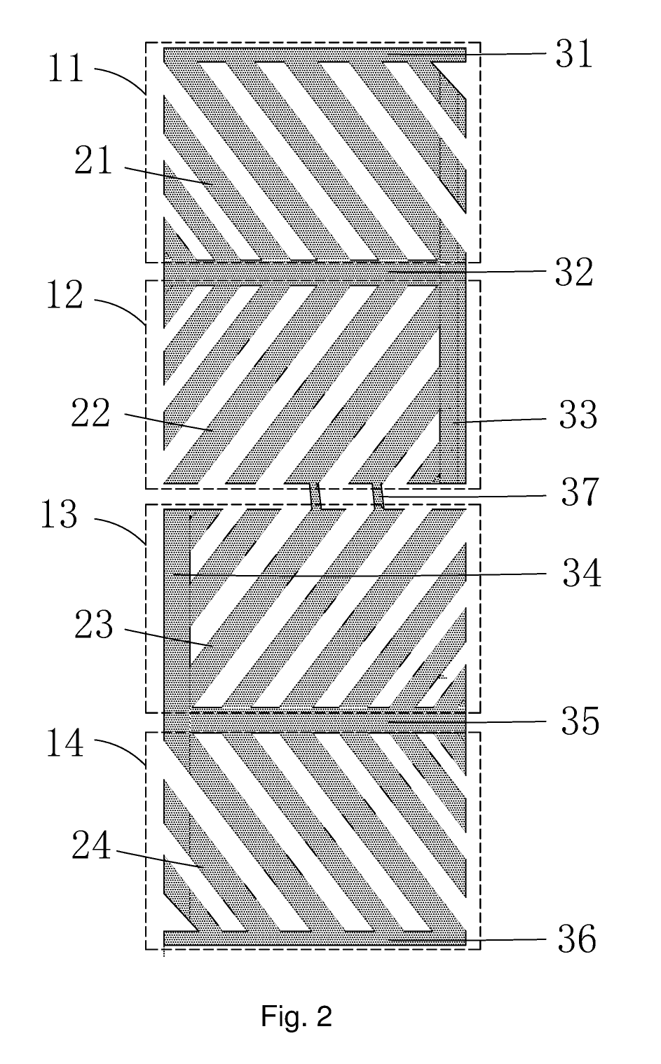

Referring to FIG. 2, FIG. 2 is a schematic view illustrating the structure of a second embodiment of the present invention, which is different from the first embodiment in that in the second embodiment of the present invention, the third and fourth connection electrodes 33, 34 are also arranged to extend in a horizontal direction. In other words, in the second embodiment of the present invention, except the seventh connection electrode 37, the remaining ones of the connection electrodes are all arranged to extend in the horizontal direction. The remaining parts are similar to those of the first embodiment and repeated descriptions will be omitted herein.

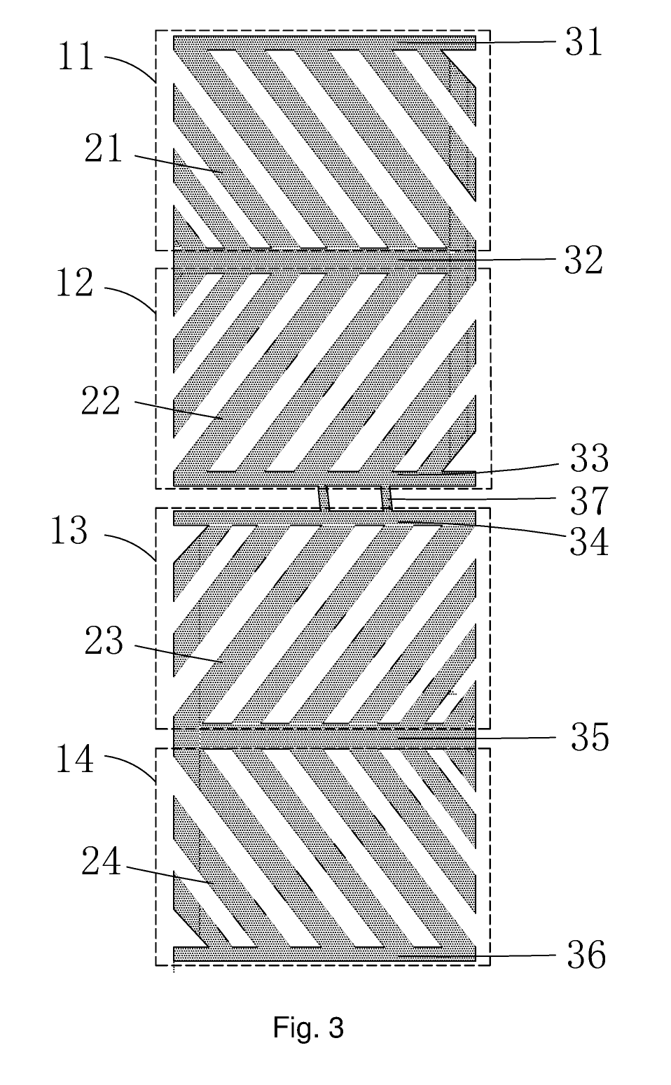

Referring to FIG. 3, FIG. 3 is a schematic view illustrating the structure of a third embodiment of the present invention, which is different from the first embodiment in that in the third embodiment of the present invention, the first, third, fourth, and sixth connection electrodes 31, 33, 34, 36 are arranged to extend in a direction that is inclined with respect to the horizontal direction, wherein the first connection electrode 31 and the fourth connection electrode 34 are inclined upward with respect to the horizontal direction, while the second connection electrode 32 and the third connection electrode 33 are inclined downward with respect to the horizontal direction. Preferably, the first, third, fourth, and sixth connection electrode 31, 33, 34, 36 are arranged to respectively extend in diagonal directions of the rectangles of the first, second, third, and fourth pixel zones 11, 12, 13, 14 and the branch electrodes of each of the electrode zones are connected, through intersection, to the connection electrode. The remaining parts are similar to those of the first embodiment and repeated descriptions will be omitted herein.

Further, it is appreciated that in other embodiments of the present invention, new examples may be provided by combining the technical solutions of the first to third embodiments. For example, the first connection electrode 31 is arranged to extend in a direction that is inclined with respect to the horizontal direction, the third connection electrode 33 is arranged to extending in the horizontal direction, the fourth connection electrode 34 is arranged to extend in a direction that is inclined with respect to the horizontal direction, and the sixth connection electrode 36 is arranged to extend in the horizontal direction, these variations being not affecting the realization of the present invention.

Based on the pixel electrode described above, the present invention also provides a curved liquid crystal display panel, which comprises: a first substrate and a second substrate that are opposite to each other, wherein the second substrate is provided with the above-described pixel electrode, where specific technical features of the pixel electrode are the same as those described above so that repeated descriptions will be omitted herein. The curved liquid crystal display panel may improve dark patterns, enhances transmission rate, and exhibits excellent displaying performance.

In summary, the present invention provides a pixel electrode. The pixel electrode is applicable to the production of a curved liquid crystal display panel and comprises four electrode zones arranged in sequence in the vertical direction. Connection electrodes are provided in each of the electrode zones and between each of the electrode zones, and each of the electrode zones is provided therein with branch electrodes, wherein the branch electrodes of each of the electrode zones are connected through the connection electrodes and among four connection electrodes that are respectively arranged in the four electrode zones, at most two are vertical electrodes that extend in the vertical direction, and the remaining ones are arranged in the horizontal direction or in directions that are inclined with respect to the horizontal direction so as to reduce influence caused by an electric field induced between the vertical electrodes on the left and right edges of the pixel electrode and thus improving dark pattern phenomenon of the liquid crystal display and increasing transmission rate. The present invention also provides a curved liquid crystal display panel, which uses the above-described pixel electrode, so as to improve the dark pattern phenomenon, enhance the transmission rate, and exhibit excellent displaying performance.

Based on the description given above, those having ordinary skills in the art may easily contemplate various changes and modifications of the technical solution and the technical ideas of the present invention. All these changes and modifications are considered belonging to the protection scope of the present invention as defined in the appended claims.

What is claimed is:

1. A pixel electrode, comprising: a plurality of first, second, third, and fourth branch electrodes, in the form of strips, and first, second, third, fourth, fifth, sixth, and seventh connection electrodes;
wherein the pixel electrode comprises first, second, third, and fourth electrode zones, which are rectangular in shape and arranged in sequence in a vertical direction from top to bottom;
the plurality of first branch electrodes are arranged in the first electrode zone and the plurality of first branch electrodes are substantially parallel to and spaced from each other, and the first connection electrode and the second connection electrode connect the plurality of first branch electrodes to each other; the plurality of second branch electrodes are arranged in the second electrode zone and the plurality of second branch electrodes are substantially parallel to and spaced from each other, and the second connection electrode and the third connection electrode connect the plurality of second branch electrodes to each other; the plurality of third branch electrodes are arranged in the third electrode zone and the plurality of third branch electrodes are substantially parallel to and spaced from each other, and the fourth connection electrode and the fifth connection electrode connect the plurality of third branch electrodes to each other; and the plurality of fourth branch electrodes are arranged in the fourth electrode zone and the plurality of fourth branch electrodes are substantially parallel to and spaced from each other, and the fifth connection electrode and the sixth connection electrode connect the plurality of fourth branch electrodes to each other; and
the first connection electrode is arranged at an upper side of the first electrode zone and extends in a horizontal direction, or alternatively, the first connection electrode is arranged in the first electrode zone and extends in a direction that is inclined with respect to the horizontal direction; the second connection electrode is arranged between the first electrode zone and the second electrode zone and extends in the horizontal direction; the third connection electrode is arranged at a left side or a right side of the second electrode zone and extends in the vertical direction, or alternatively, the third connection electrode is arranged at a lower side of the second electrode zone and extends in the horizontal direction, or alternatively, the third connection electrode is arranged in the second electrode zone and extends in a direction that is inclined with respect to the horizontal direction; the fourth connection electrode is arranged at a left side or a right side of the third electrode zone and extends in the vertical direction, or alternatively, the fourth connection electrode is arranged at an upper side of the third electrode zone and extends in the horizontal direction, or alternatively, the fourth connection electrode is arranged in the third electrode zone and extends in a direction that is inclined with respect to the horizontal direction; the fifth connection electrode is arranged between the third electrode zone and the fourth electrode zone and extends in the horizontal direction; the sixth connection electrode is arranged at a lower side of the fourth electrode zone and extends in the horizontal direction, or alternatively, the sixth connection electrode is arranged in the fourth electrode zone and extends in a direction that is inclined with respect to the horizontal direction; and the seventh connection electrode is arranged between the second electrode zone and the third electrode zone and connects the electrodes of the second electrode zone and the third electrode zone together.

2. The pixel electrode as claimed in claim 1, wherein the plurality of first and fourth branch electrodes are both inclined with respect to the horizontal direction by a degrees and the plurality of second and third branch electrodes are both inclined with respect to the horizontal direction by a+90 degrees, where a is greater than 0 and smaller than 90.

3. The pixel electrode as claimed in claim 2, wherein the plurality of first and fourth branch electrodes are both inclined with respect to the horizontal direction by 45 degrees and the plurality of second and third branch electrodes are both inclined with respect to the horizontal direction by 135 degrees.

4. The pixel electrode as claimed in claim 1, wherein the pixel electrode is formed of a material comprising a metal or a metal oxide.

5. The pixel electrode as claimed in claim 4, wherein the material of the pixel electrode is indium tin oxide (ITO).

6. A curved liquid crystal display panel, comprising: a first substrate and a second substrate that are opposite to each other, the second substrate comprising a pixel electrode arranged thereon;
wherein the pixel electrode comprises: a plurality of first, second, third, and fourth branch electrodes, in the form of strips, and first, second, third, fourth, fifth, sixth, and seventh connection electrodes;
wherein the pixel electrode comprises first, second, third, and fourth electrode zones, which are rectangular in shape and arranged in sequence in a vertical direction from top to bottom;
the plurality of first branch electrodes are arranged in the first electrode zone and the plurality of first branch electrodes are substantially parallel to and spaced from each other, and the first connection electrode and the second connection electrode connect the plurality of first branch electrodes to each other; the plurality of second branch electrodes are arranged in the second electrode zone and the plurality of second branch electrodes are substantially parallel to and spaced from each other, and the second connection electrode and the third connection electrode connect the plurality of second branch electrodes to each other; the plurality of third branch electrodes are arranged in the third electrode zone and the plurality of third branch electrodes are substantially parallel to and spaced from each other, and the fourth connection electrode and the fifth connection electrode connect the plurality of third branch electrodes to each other; and the plurality of fourth branch electrodes are arranged in the fourth electrode zone and the plurality of fourth branch electrodes are substantially parallel to and spaced from each other, and the fifth connection electrode and the sixth connection electrode connect the plurality of fourth branch electrodes to each other; and
the first connection electrode is arranged at an upper side of the first electrode zone and extends in a horizontal direction, or alternatively, the first connection electrode is arranged in the first electrode zone and extends in a direction that is inclined with respect to the horizontal direction; the second connection electrode is arranged between the first electrode zone and the second electrode zone and extends in the horizontal direction; the third connection electrode is arranged at a left side or a right side of the second electrode zone and extends in the vertical direction, or alternatively, the third connection electrode is arranged at a lower side of the second electrode zone and extends in the horizontal direction, or alternatively, the third connection electrode is arranged in the second electrode zone and extends in a direction that is inclined with respect to the horizontal direction; the fourth connection electrode is arranged at a left side or a right side of the third electrode zone and extends in the vertical direction, or alternatively, the fourth connection electrode is arranged at an upper side of the third electrode zone and extends in the horizontal direction, or alternatively, the fourth connection electrode is arranged in the third electrode zone and extends in a direction that is inclined with respect to the horizontal direction; the fifth connection electrode is arranged between the third electrode zone and the fourth electrode zone and extends in the horizontal direction; the sixth connection electrode is arranged at a lower side of the fourth electrode zone and extends in the horizontal direction, or alternatively, the sixth connection electrode is arranged in the fourth electrode zone and extends in a direction that is inclined with respect to the horizontal direction; and the seventh connection electrode is arranged between the second electrode zone and the third electrode zone and connects at least one of the second branch electrodes to the third branch electrodes.

7. The curved liquid crystal display panel as claimed in claim 6, wherein the plurality of first and fourth branch electrodes are both inclined with respect to the horizontal direction by a degrees and the plurality of second and third branch electrodes are both inclined with respect to the horizontal direction by a+90 degrees, where a is greater than 0 and smaller than 90.

8. The curved liquid crystal display panel as claimed in claim 7, wherein the plurality of first and fourth branch electrodes are both inclined with respect to the horizontal direction by 45 degrees and the plurality of second and third branch electrodes are both inclined with respect to the horizontal direction by 135 degrees.

9. The curved liquid crystal display panel as claimed in claim 6, wherein the pixel electrode is formed of a material comprising a metal or a metal oxide.

10. The curved liquid crystal display panel as claimed in claim 9, wherein the material of the pixel electrode is indium tin oxide (ITO).

11. A curved liquid crystal display panel, comprising: a first substrate and a second substrate that are opposite to each other, the second substrate comprising a pixel electrode arranged thereon;
wherein the pixel electrode comprises: a plurality of first, second, third, and fourth branch electrodes, in the form of strips, and first, second, third, fourth, fifth, sixth, and seventh connection electrodes;
wherein the pixel electrode comprises first, second, third, and fourth electrode zones, which are rectangular in shape and arranged in sequence in a vertical direction from top to bottom;
the plurality of first branch electrodes are arranged in the first electrode zone and the plurality of first branch electrodes are substantially parallel to and spaced from each other, and the first connection electrode and the second connection electrode connect the plurality of first branch electrodes to each other; the plurality of second branch electrodes are arranged in the second electrode zone and the plurality of second branch electrodes are substantially parallel to and spaced from each other, and the second connection electrode and the third connection electrode connect the plurality of second branch electrodes to each other; the plurality of third branch electrodes are arranged in the third electrode zone and the plurality of third branch electrodes are substantially parallel to and spaced from each other, and the fourth connection electrode and the fifth connection electrode connect the plurality of third branch electrodes to each other; and the plurality of fourth branch electrodes are arranged in the fourth electrode zone and the plurality of fourth branch electrodes are substantially parallel to and spaced from each other, and the fifth connection electrode and the sixth connection electrode connect the plurality of fourth branch electrodes to each other; and
the first connection electrode is arranged at an upper side of the first electrode zone and extends in a horizontal direction, or alternatively, the first connection electrode is arranged in the first electrode zone and extends in a direction that is inclined with respect to the horizontal direction; the second connection electrode is arranged between the first electrode zone and the second electrode zone and extends in the horizontal direction; the third connection electrode is arranged at a left side or a right side of the second electrode zone and extends in the vertical direction, or alternatively, the third connection electrode is arranged at a lower side of the second electrode zone and extends in the horizontal direction, or alternatively, the third connection electrode is arranged in the second electrode zone and extends in a direction that is inclined with respect to the horizontal direction; the fourth connection electrode is arranged at a left side or a right side of the third electrode zone and extends in the vertical direction, or alternatively, the fourth connection electrode is arranged at an upper side of the third electrode zone and extends in the horizontal direction, or alternatively, the fourth connection electrode is arranged in the third electrode zone and extends in a direction that is inclined with respect to the horizontal direction; the fifth connection electrode is arranged between the third electrode zone and the fourth electrode zone and extends in the horizontal direction; the sixth connection electrode is arranged at a lower side of the fourth electrode zone and extends in the horizontal direction, or alternatively, the sixth connection electrode is arranged in the fourth electrode zone and extends in a direction that is inclined with respect to the horizontal direction; and the seventh connection electrode is arranged between the second electrode zone and the third electrode zone and connects at least one of the second branch electrodes to the third branch electrodes;
wherein the plurality of first and fourth branch electrodes are both inclined with respect to the horizontal direction by a degrees and the plurality of second and third branch electrodes are both inclined with respect to the horizontal direction by a+90 degrees, where a is greater than 0 and smaller than 90; and
wherein the pixel electrode is formed of a material comprising a metal or a metal oxide.

12. The curved liquid crystal display panel as claimed in claim 11, wherein the plurality of first and fourth branch electrodes are both inclined with respect to the horizontal direction by 45 degrees and the plurality of second and third branch electrodes are both inclined with respect to the horizontal direction by 135 degrees.

13. The curved liquid crystal display panel as claimed in claim 11, wherein the material of the pixel electrode is indium tin oxide (ITO).
